(19) United States
(12) Patent Application Publication
(10) Pub. No.: US 2004/0203775 A1
(43) Pub. Date: Oct. 14, 2004

(54) Method for allowing access to services in a cellular mobile radiocommunication system

(76) Inventors: Stanislas Bourdeaut, Paris (FR); Vincent Muniere, Meudon (FR); Francois Courau, Meudon (FR)

Correspondence Address: SUGHRUE MION, PLLC, 2100 PENNSYLVANIA AVENUE, N.W., SUITE 800, WASHINGTON, DC, 20037, US

(21) Appl. No.: 10/476,849

(22) PCT Filed: May 6, 2002
(86) PCT No.: PCT/FR02/01550

(30) Foreign Application Priority Data
May 7, 2001 (FR) 01/06092

(51) Int. Cl. H04Q 7/20

(52) U.S. Cl. 455/435.1

(57) ABSTRACT

A method of allowing access to services in a cellular mobile radio system in which different services are available and in which prior registration is necessary to allow a given user to access given services, said method being essentially characterized in that an attempt to register a user for services that are not allowed initiates the execution of procedures for registering that user for services that are allowed.

The present invention relates generally to mobile radio systems, i.e. cellular mobile radio networks and mobile stations used in such networks.

As general rule, such systems are covered by standards and more information can be obtained by referring to the corresponding standards published by the corresponding standards bodies.

As the person skilled in the art is well aware, in a system such as the Global System for Mobile communications (GSM), for example, there are two different mobile station operating modes:

a dedicated mode, in which a mobile station has one or more channels known as dedicated channels available, and

a standby mode, in which a mobile station does not have any dedicated channels available, but must nevertheless remain in contact with the network, using channels known as common channels.

As a general rule, these systems have a cellular architecture and, in outline, the cell selection process in standby mode is as follows:

Each cell is associated with a particular frequency called the beacon frequency. The mobile station receives first system information consisting of a list of beacon frequencies associated with cells adjoining its server cell on a common channel called the broadcast control channel (BCCH) transmitted at the beacon frequency of its server cell. The mobile station then scans each beacon frequency in succession, firstly to carry out radio measurements on it and secondly, after synchronization, to acquire second system information consisting of a number of parameters which, combined with the radio measurement results, determine whether a selection criterion is verified for that beacon frequency, after which the cell to be selected is determined by comparison with the results obtained in the same way for the other beacon frequencies.

Furthermore, each time a mobile station is switched on, at which time no server cell has been selected, the mobile station selects a server cell in accordance with the same principles, but scans all the beacon frequencies.

After selecting a cell in the manner outlined above, the access rights of the user are verified, as a function of subscription data of the user and, where applicable, in the case of a “roaming” user, as a function of roaming agreements between carriers. The systems are generally formed of a plurality of separate public land mobile networks (PLMN), generally operated by different carriers, among other things to expand the geographical coverage and/or the services offered.

In outline, the access rights verification procedure is as follows: using third system information broadcast on the beacon frequency of the selected cell, the mobile station determines whether the cell belongs to the same geographical area as its current server cell or not. In the case of the GSM, the geographical area concerned is called a location area (LA) and in the case of the General Packet Radio Service (GPRS), the geographical area concerned is called a routing area (RA). These terms are used interchangeably hereinafter. If the selected cell belongs to the same location area as the server cell, the selected cell becomes the new server cell. If not, the mobile station advises the network of this beforehand, by means of a location updating procedure, in order to have the network verify the user's right to access the selected cell.

In the context of this location updating procedure, the mobile station sends the network a “Location Area Updating Request” message.

In the event of a positive response from the network, the network sends back to the mobile station a “Location Area Updating Accept” message. The user is then registered in the new location area and the selected cell becomes the new server cell.

In the event of a negative response from the network, the network sends back to the mobile station a “Location Area Updating Reject” message and indicates the cause of rejection.

At present, in systems such as the GSM in particular, there are three causes of rejection:

The selected cell belongs to a PLMN that is not allowed. In this case, the cause of rejection is “PLMN not allowed”, and the mobile station selects another PLMN. Furthermore, on receiving a “PLMN not allowed” cause, the PLMN that is not allowed is added to a “Forbidden PLMN list” stored in the subscriber identity module (SIM) card associated with the mobile station to prevent any further attempt to register in that PLMN.

The selected cell belongs to a location area that is not allowed. In this case, the cause of rejection is “Location Area not allowed” and the mobile station does not select another PLMN, unless the user changes location area.

The selected cell is situated in a location area that does not accept visitors from another PLMN. In this case, the cause of rejection is “Roaming not allowed in this Location Area”.

The present invention relates more particularly to the problems arising in this context from system changes related in particular to the introduction of new services and more especially the introduction of new radio access technologies. In these systems, second generation radio access technologies, in particular of the GSM type, are distinguished from third generation radio access technologies, in particular of Universal Mobile Telecommunication System (UMTS) type.

In particular, the applicant has observed that some situations give rise to specific problems in determining the cause of rejection that applies when an attempt to register must be rejected.

A first situation is of the following type:

a carrier A has a GSM network and a UMTS network identified by the same PLMN code,

a user has a contract with the carrier A limited to the GSM, and

the user is using a GSM/UMTS dual mode terminal with his SIM card.

In this situation, an attempt to register this user in a cell of the UMTS network of carrier A must be rejected.

A second situation is of the following type:

two carriers A and B operate in different countries,

carrier A has a GSM network and a UMTS network identified by the same PLMN code,

carrier B has either a GSM network only or a GSM network and a UMTS network,

carriers A and B have a roaming agreement for the GSM only,

a user has a contract with carrier B limited to the GSM, and

the user is traveling abroad in the coverage area of the network of carrier A and is using a GSM/UMTS dual mode terminal.

In this situation, an attempt to register the user in a cell of the UMTS network of carrier A must be rejected.

A third situation is of the following type:

two carriers A and B operate in the same country,

each of the two carriers has at least one network, for example a UMTS network,

a UMTS network is operated in a given region only by carrier A (the region concerned is known as a shared zone and typically has a very low traffic density),

there is a roaming agreement between carriers A and B for the shared zone, and

a user has a contract with carrier B for the UMTS network.

In this situation, an attempt to register the user in a cell of the UMTS network of carrier A must be allowed only within the shared zone and rejected outside the shared zone.

In the above situations at least, the various causes of rejection outlined above are not suitable, essentially for the following reasons:

“PLMN not allowed”: this cause cannot be used since in the first two situations both networks have the same PLMN code (a network or PLMN being identified by its PLMN code, in particular for the requirements of these procedures), while in the third situation, if this cause were used, registration of the user in the shared zone could not be attempted afterwards,

“Location Area not allowed”: this cause cannot be used because, on receiving a message containing this cause, the mobile station does not select another PLMN unless it changes location area, and

“Roaming not allowed in this Location Area”: this cause cannot be used in this situation either.

At present, carriers must use either different PLMN codes or different location areas for different radio access technologies. Using different PLMN codes for different radio access technologies may not be possible in some countries (for example France). If different location areas are used, the causes that are currently contained in the message rejecting location updating rule out initiating selection of another PLMN (unless the mobile station changes location area).

One particular object of the present invention is to provide a solution to the above problems. The invention is of general application and is not limited to the situations described above by way of example.

Accordingly, the present invention consists in a method of allowing access to services in a cellular mobile radio system in which different services are available and in which prior registration is necessary to allow a given user to access given services, said method being essentially characterized in that an attempt to register a user for services that are not allowed initiates the execution of procedures for registering that user for services that are allowed.

According to another feature, said services that are not allowed and said services that are allowed respectively correspond to services available in a first network or PLMN and a second network or PLMN of the same carrier.

According to another feature, said services that are not allowed correspond to services available in a first network or PLMN of a first carrier and said services that are allowed correspond to services available in a second network or PLMN of the first carrier and in a network or PLMN of a second carrier having a roaming agreement with the first carrier for the services available in its second network.

According to another feature, different services correspond to different radio access technologies.

According to another feature, different radio access technologies include second generation radio access technologies and third generation radio access technologies.

According to another feature, said first network and said second network are identified by the same code or PLMN code.

According to another feature, for a user of a first carrier, said services that are allowed correspond, outside a given area referred to as a shared zone, to services available in a network or PLMN of said first carrier or, inside said shared zone, to services available in a network or PLMN of a second carrier and said services that are not allowed correspond, outside said shared zone, to services available in the network of the second carrier.

According to another feature, said procedures for registering the user for services that are allowed include network or PLMN reselection.

According to another feature, an allowed services list for each user is stored in the network.

According to another feature, said allowed services list for each user is stored in the network in a mobile user database.

According to another feature, an allowed services list is stored in a mobile station user identification module.

According to another feature, said allowed services list is an allowed services list for each network or PLMN identified by a given PLMN code.

According to another feature, different services correspond to different radio access technologies.

According to another feature, different radio access technologies include second generation radio access technologies and third generation radio access technologies.

According to another feature, said mobile user database is a home location register (HLR).

According to another feature, said mobile station user identification module is an SIM/USIM card.

According to another feature, in the event of an attempt to register a user for services that are not allowed, the network entity concerned sends the mobile station a corresponding message including a “Service not allowed” cause of rejection.

According to another feature, on receiving said message, the mobile station selects a new network or PLMN.

According to another feature, in the event of an attempt to register a user for services that are not allowed:

the network entity concerned sends the PLMN code concerned to a mobile user database,

the mobile user database sends back to the network entity concerned the allowed services list for each PLMN for that user,

on this basis, the network entity concerned agrees to offer the requested service or not, and

if it does not agree to offer the requested service, it sends the mobile station a corresponding message, including a “Service not allowed” cause of rejection.

According to another feature, in the event of an attempt to register a user for given services, the mobile station further sends the network entity concerned an allowed services list for each PLMN as stored in a user identification module of the mobile station.

The invention also provides a mobile radio system including means for implementing the above method.

The invention also provides a mobile radio network entity including means for implementing the above method.

The invention also provides a mobile user database including means for implementing the above method.

The invention also provides a mobile station including means for implementing the above method.

The invention also provides a mobile station user identification module including means for implementing the above method.

Other objects and features of the present invention become apparent on reading the following description of embodiments of the invention, which is given with reference to the appended drawings, in which:

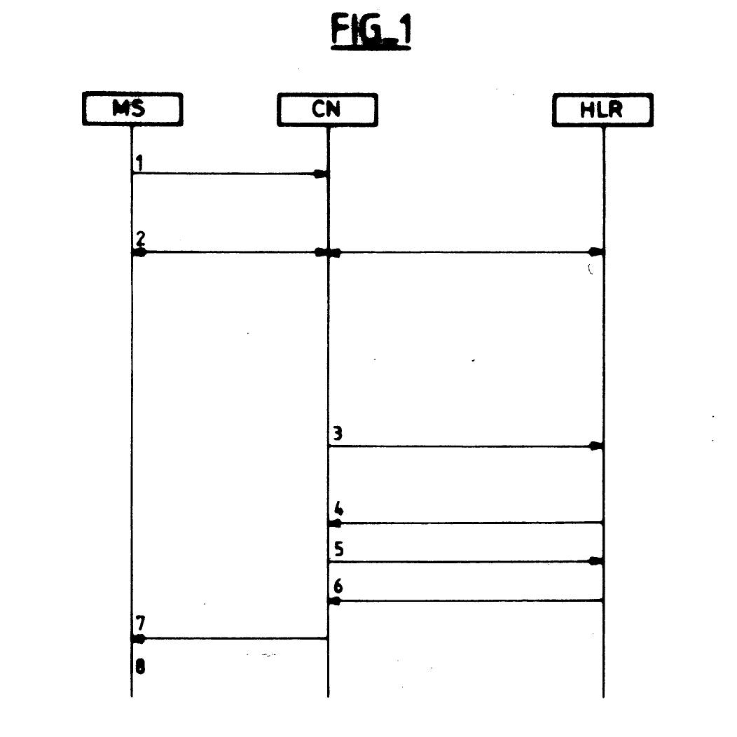

FIG. 1 shows a first embodiment of the method of the invention, and

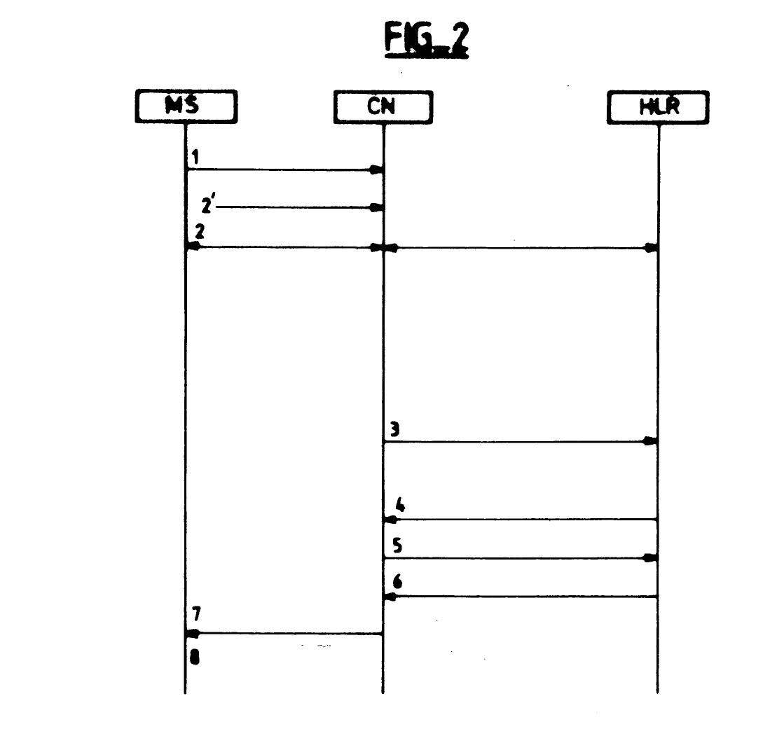

FIG. 2 shows a second embodiment of the method of the invention.

Embodiments of the present invention can be described in the following manner:

A new cause of rejection of location updating, “Service not allowed”, is introduced.

On receiving a “Service not allowed” cause, the mobile station can immediately select another PLMN.

An allowed services list, stored in a mobile user database such as the home location register (HLR), must be provided for each user. This list can indicate the allowed services in each PLMN for each user. For example, the allowed services in each PLMN can include the allowed radio access technology or technologies, the allowed area or areas, etc.

An allowed services list for each user in each PLMN can therefore be stored in the HLR.

During a location updating procedure, the network entity concerned contacts the HLR to tell it the PLMN concerned, and the HLR responds by sending it the allowed services list for that PLMN.

The network entity concerned can then agree or not to offer the service and, as appropriate, send a “Location Area Updating Accept” message or a “Location Area Updating Reject” message, with an appropriate cause of rejection in the latter case.

On receiving a “Service not allowed” cause of rejection, the mobile station can immediately select another PLMN. Generally speaking, in these systems, PLMN reselection can be controlled by the user to a greater or lesser degree. Thus it can be entirely controlled by the user (who then chooses the PLMN to reselect), not controlled by the user at all (in which case all beacon frequencies are scanned, as when switching on the mobile station), or partly controlled by the user (in which case only some of the beacon frequencies are scanned, based on a “PLMN preferred list” stored in the SIM card associated with the mobile station). In this case there can be provision for the mobile station not to reselect the same PLMN before receiving the “Service not allowed” cause of rejection.

An allowed services list could also be stored in the user's Subscriber Identity Module/Universal Subscriber Identity Module (SIM/USIM) card. In particular, this kind of list could be associated with a “PLMN preferred list” also stored in the card. The allowed services list stored in the SIM/USIM card can likewise indicate the services allowed in each PLMN for the user concerned.

An “Allowed services list” can therefore be stored in the SIM/USIM card.

The mobile station can use the allowed services list when it selects a PLMN.

In the event of location updating, the mobile station can send the allowed services in the PLMN concerned, stored in this list, to the network entity concerned in the “Location Updating Request” message. The mobile station, having read the corresponding PLMN code on the BCCH, can then send the network the allowed services stored in the list for this PLMN (for example the allowed radio access technology) in this message.

The network can compare the “MS allowed services list” received from the mobile station (MS) to its “NW allowed services list” (“NW” signifies network). The network agrees to offer the service or not and sends the mobile station either a “Location Area Updating Accept” message or a “Location Area Updating Reject” message, in the latter case with the appropriate cause of rejection.

On receiving a “Service not allowed” cause of rejection, the mobile station can immediately select another PLMN. Likewise, where applicable, there can be provision for the mobile station not to reselect the same PLMN before receiving the “Service not allowed” cause of rejection.

If a new roaming agreement is signed, the “NW allowed services list” must be updated in the HLR. The “MS allowed services list” could also be updated, for example using the “SIM Toolkit”.

If this information is not present, a minimum default set of services must be considered, for example “Phase 2+” services in the case of packet mode services (“PS domain”) or “Phase 2” services in the case of circuit mode services (“CS domain”).

More detailed examples of the procedures employed are described next with reference to FIGS. 1 and 2. The method shown in these figures is described in terms of process steps involving the entities MS, CN and HLR.

As a general rule, the architecture of a cellular mobile radio system essentially includes:

an access network (AN), and

a core network (CN).

In a GSM/GPRS system the access network is known as the network subsystem (NSS) and the core network is known as a base station subsystem (BSS).

The access network AN communicates firstly with mobile stations (MS) and secondly with the core network. The core network itself communicates firstly with the access network (AN) and secondly with external networks and with a mobile user database (such as the home location register (HLR) in particular).

In a GSM/GPRS system, the core network essentially contains network entities, also known as network nodes, such as mobile switching centers (MSC) communicating with external networks in circuit mode, serving GPRS support nodes (SGSN), and gateway GPRS support nodes (GGSN), the latter communicating with external networks in packet mode.

The procedures shown by way of example in FIGS. 1 and 2 correspond more particularly to the GSM/GPRS system. For more information on the procedures used in this system, in particular the location updating procedures, see the corresponding standards published by the corresponding standards bodies.

FIG. 1 corresponds to a situation in which an allowed services list is stored in the HLR only. The procedure shown by way of example in FIG. 1 includes the following steps:

In a step 1, the MS sends the CN entity concerned a “Routing/Location Update Request” message; the entity concerned, to which the above kind of message must be sent, is also referred to as a new entity, for example a new SGSN. The BSS adds a “Cell Global Identity” including the “Routing Area Code” (RAC) and the “Location Area Code” (LAC) of the cell in which the message has been received before forwarding the message to the core network CN.

In a step 2, security functions can be executed. The encryption mode is established if encryption is supported.

In a step 3, the CN informs the HLR of a change of SGSN by sending it an “Update Location” message. In this case the HLR receives the corresponding PLMN code in this message.

In a step 4, the HLR sends the CN an “Insert Subscriber Data” message including the International Mobile Subscriber Identity (IMSI) and GPRS subscription data. In this case the HLR also sends the CN the “NW allowed service list” in this message.

The CN can then validate the presence of the MS in the new Routing Area/Location Area (RA/LA). If registration of the MS in the new RA/LA is not allowed, because of restrictions relating to the user's contract, the CN rejects the RA/LA updating request. In this case, if the user is not allowed the available service, the CN rejects the RA/LA updating request with the “Service not allowed” cause of rejection. If all the verifications are successful, the CN establishes a Mobility Management (MM) context.

In a step 5, the CN acknowledges receipt of the “Insert Subscriber Data” message by sending the HLR an “Insert Subscriber Data Ack” message; this message can be different according to whether the MS is allowed to be registered in the new RA/LA or not.

In a step 6, the HLR acknowledges the “Update Location” message by sending the CN an “Update Location Ack” message.

In a step 7, the CN sends the MS a “Routing/Location Area Update Accept” message or a “Routing/Location Area Update Reject” message, as appropriate, in the latter case with the appropriate cause of rejection.

As indicated by a step 8: if the user is not allowed the service available, the “Service not allowed” cause of rejection is sent to the MS, which can then select a new PLMN immediately. If necessary, there can be provision for the mobile station not to reselect the same PLMN before receiving the “Service not allowed” cause of rejection. For example, the CN can send the MS the allowed services list if necessary, in particular in the “Routing/Location Area Update Reject” message.

FIG. 2 corresponds to a situation in which an allowed services list is also stored in the SIM/USIM card. The procedure shown in FIG. 2 includes steps similar to those shown in FIG. 1, and for simplicity the steps are identified by the same numbers. Moreover:

In an additional step 2′, after it has decoded the PLMN code in the system information broadcast in the cell concerned, the MS can send the CN its allowed services list for that PLMN, as read from the SIM card.

The CN can compare the allowed services list received from the mobile station (“MS allowed services list”) and the network allowed services list (“NW allowed services list”) before deciding if the user is allowed the available service or not.

The “MS allowed services list” can be different from the “NW allowed services list” in at least two situations:

if a new roaming agreement has been signed and the “MS allowed service list” has not yet been updated, and

if the SIM card is fraudulent.

The above kind of comparison can enable the network to detect inconsistencies between the two lists, which could if necessary lead to updating of the SIM card, for example using the “SIM Toolkit”.

The present invention also provides a mobile radio system, a mobile radio network entity, a mobile user database, a mobile station, and a mobile station user identification module all including means for implementing a method of the invention.

Said means can operate in accordance with the method as previously described; their particular implementation representing no particular problem for the person skilled in the art, they do not need to be described here in more detail than by stating their function.

1. A method of allowing access to services in a cellular mobile radio system in which different services are available and in which prior registration is necessary to allow a given user to access given services, said method being characterized in that an attempt to register a user for services that are not allowed initiates the execution of procedures for registering that user for services that are allowed.

2. A method according to claim 1, wherein said services that are not allowed and said services that are allowed respectively correspond to services available in a first network or PLMN and a second network or PLMN of the same carrier.

3. A method according to claim 1, wherein said services that are not allowed correspond to services available in a first network or PLMN of a first carrier and said services that are allowed correspond to services available in a second network or PLMN of the first carrier and in a network or PLMN of a second carrier having a roaming agreement with the first carrier for the services available in its second network.

4. A method according to claim 1, wherein different services correspond to different radio access technologies.

5. A method according to claim 4, wherein different radio access technologies include second generation radio access technologies and third generation radio access technologies.

6. A method according to claim 2, wherein said first network and said second network are identified by the same code or PLMN code.

7. A method according to claim 1, wherein for a user of a first carrier, said services that are allowed correspond, outside a given area referred to as a shared zone, to services available in a network or PLMN of said first carrier or, inside said shared area, to services available in a network or PLMN of a second carrier and said services that are not allowed correspond, outside said shared zone, to services available in the network of the second carrier.

8. A method according to claim 1, wherein said procedures for registering the user for services that are allowed include network or PLMN reselection.

9. A method according to claim 1, wherein an allowed services list for each user is stored in the network.

10. A method according to claim 9, wherein said allowed services list for each user is stored in the network in a mobile user database.

11. A method according to claim 1, wherein an allowed services list is stored in a mobile station user identification module.

12. A method according to claim 9, wherein said allowed services list is an allowed services list for each network or PLMN identified by a given PLMN code.

13. A method according to claim 9, wherein different services correspond to different radio access technologies.

14. A method according to claim 13, wherein different radio access technologies include second generation radio access technologies and third generation radio access technologies.

15. A method according to claim 10, wherein said mobile user database is a home location register (HLR).

16. A method according to claim 12, wherein said mobile station user identification module is an SIM/USIM card.

17. A method according to claim 1, wherein, in the event of an attempt to register a user for services that are not allowed, the network entity concerned sends the mobile station a corresponding message including a “Service not allowed” cause of rejection.

18. A method according to claim 17, wherein, on receiving said message, the mobile station selects a new network or PLMN.

19. A method according to claim 1, wherein, in the event of an attempt to register a user for services that are not allowed:
the network entity concerned sends the PLMN code concerned to a mobile user database,
the mobile user database sends back to the network entity concerned the allowed services list for each PLMN for that user,
on this basis, the network entity concerned agrees to offer the requested service or not, and
if it does not agree to offer the requested service, it sends the mobile station a corresponding message, including a “Service not allowed” cause of rejection.

20. A method according to claim 19, wherein, in the event of an attempt to register a user for given services, the mobile station further sends the network entity concerned an allowed services list for each PLMN as stored in a user identification module of the mobile station.

21. A mobile radio system including means for implementing a method according to claim 1.

22. A mobile radio network entity including means for implementing a method according to claim 1.

23. A mobile user database including means for implementing a method according to claim 1.

24. A mobile station including means for implementing a method according to claim 1

25. A mobile station user identification module including means for implementing a method according to claim 1.
